(19) United States
(12) Patent Application Publication
(10) Pub. No.: US 2005/0030563 A1
(43) Pub. Date: Feb. 10, 2005

(54) Test print, test print production system and test print production method, for photographic print

(75) Inventors: Muneyoshi Matsunami, Tokyo (JP); Shigeru Takeuchi, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/910,366

(22) Filed: Aug. 4, 2004

(30) Foreign Application Priority Data
Aug. 8, 2003 (JP) JP2003-289946

(51) Int. Cl. H04N 1/50; H04N 1/58; H04N 1/60

(52) U.S. Cl. 358/1.9; 358/538; 358/527; 358/504; 358/518

(57) ABSTRACT

A test print of a processed photographic film, including a photo-printed roll or sheet wherein a plurality of test paper areas which are selected and cropped from image frames of a processed photographic film are linearly printed, and identification information about the test print area correlating to each image frame are printed on the same surface as the test print area of each image frame.

### BACKGROUND OF THE INVENTION

The present invention relates to a test print for checking the finished condition of a photographic print, a test print production system and a test print production method.

When a customer brings an image-exposed film (hereinafter referred to as a film) to a photo-finishing laboratory such as a mini-laboratory, the laboratory develops the film, and prints images onto a photosensitive material, to produce photographic prints. Concerning a production method of the photographic prints, there are two methods (a first method) wherein after the images are exposed onto a rolled photosensitive material, the printed images are cut individually into desired sizes, and the other method (a second method) wherein the image is exposed onto a photosensitive material which is previously cut into a desired size.

The first method will be explained referring to FIG. 9. FIG. 9 shows a photographic process of a print producing apparatus. In the first method, firstly, rolled photosensitive material 24 is pulled out from photosensitive material storage section 20, each image on the developed film is exposed onto rolled photosensitive material 24 in exposure section 21, and rolled photosensitive material 24 is photographically processed in processing section 22, and finally, rolled photosensitive material 24 is cut into the individual desired print size, which become photographic print 26. This method, wherein the rolled photosensitive material is cut after the image is processed, is called a roll conveyance method, which is specifically explained in Japanese Tokkaihei 8-160541.

In the first method, if the photosensitive material has not at least a predetermined length, the photosensitive material cannot be conveyed due to the structural configuration of the print producing apparatus, and thereby, a small area, carrying not printed image 25, is generated at the end of a series of photographic prints 26a near the end of the processed rolled photosensitive material. Therefore, in the second method, when a small number of photographic prints 26 are produced, photographic prints 26 are produced by a method shown in FIGS. 10(A)-10(D). Specifically, rolled photosensitive material 24 is pulled out from photosensitive material storage section 20, and is cut into the desired size (for example, a length of 150 mm) in cutting section 23, after which this cut photosensitive material 24a is conveyed to exposure section 21, where image on the film is exposed onto cut photosensitive material 24, next, the cut and exposed photosensitive material 24a is conveyed to processing section 22 for processing, that is, where photographic prints 26 are produced. This method, wherein the rolled photosensitive material is previously cut into a predetermined size, and the exposure and the development processing are conducted, is called a cut conveyance method.

Whichever method is used, the finished quality of photographic print 26 is determined by the condition of the exposure and photographic process (which collectively means printing settings), however if there is no specific request from the customer, the photographic prints are produced by the standard printing settings in the photo-finishing laboratory. Typical customers are sufficiently satisfied with photographic print 26 produced by the above standard printing settings, however, in the case of photography which is taken by a photographic specialist in a photographic studio (which is a so called professional studio photography), the photographic specialist demands a high-level of quality in the produced prints, and therefore it often is the case in which a sufficiently finished quality is not obtained by the standard printing settings. Therefore, in the case of the professional studio photography, test prints are repeated for several times before producing a salable photographic print 26 (that is, before the actual printing), and the correction for such as color balance is conducted, to establish the printing settings acceptable for the specialist. A print producing procedure in the professional studio photography will be explained referring to the flowchart in FIG. 11.

Firstly, in step S201, a photographer in the photographic studio captures an image, and brings the exposed film (which is normally Brownie size, being 6×9 cm) to a photo-finishing laboratory such as a mini-laboratory. The photo-finishing laboratory typically receives several exposed rolls of film in one group from one photographic studio. In step S202, these films are sequentially processed, and each processed film is cut into units of three continuous frames, and are then sent back to the photographic studio. Next, in step S203, after the photographic studio checks the condition of the processed film sent back from the photo-finishing laboratory, desired frames are selected for printing, and orders print production of the selected frames to the photo-finishing laboratory.

Next, in step S204, in the photo-finishing laboratory, to obtain the printing settings having the optimum color balance for the specified frame which will be fully acceptable by the photo studio, a test print of the same print size of the actual print is produced, and in step S205, the condition of the test print is checked, and such test printing is repeated until the optimum print settings are obtained. When the test print is produced which will be acceptable by the photo studio, the actual print is produced employing the optimum print settings, and in step S206, the print is returned to the photo studio.

Recently, a digital camera is also used for capturing image in the photo studio. That is, concerning image capturing media, there are a photographic film for an analog camera, a compact flash, SD card, and MD card, for the digital camera, and CD-R, DVD-R, DVD +R, DVD-RAM for recording image data. In order to determine a printer setting data, the photo studio must make the test print before an actual print, when the above mentioned image capturing media are used.

[Patent Document 1] Japanese Tokkaihei 8-160541 (pages 16-24, FIG. 3)

By repeated test printing, it is possible to produce the photographic prints with the color balance which are expected by the photo studio, however, if test prints are performed too many times, the consumption of photosensitive materials becomes excessive. Further, since each test print is produced in a cut shape by the above described method, it is necessary to correlate each test print with each frame of the photographic film, and correlating work takes a long time for the operator, and thereby obtaining the optimum printing settings takes a long time for the operator, which is a problem.

Since the test prints are performed for the purpose of obtaining the optimum printing settings, it is not necessary to produce test prints for the total area of the frame, but for checking the color balance, it is only necessary to produce a test print for a specified area, such as a human face. In order to reduce consumption of the photosensitive materials, there is a method wherein a partial area of the frame of the film is successively exposed onto the rolled photosensitive material. Specifically for producing test prints, firstly, a desired area of the frame is defined by a slit and is exposed onto the rolled photosensitive material, next, the rolled photosensitive material is fed for the width of the slit and the margined length, and, the defined area of the next frame, defined by the slit, is exposed. This operation is repeated successively, and finally produced are test print 15 wherein rectangular cropped images are successively printed (that is, rectangular and partial areas of each frame of the film are printed as test prints), shown in FIG. 12. This method can greatly reduce the consumption of the photosensitive materials compared to the method wherein the total area of each frame is printed for the test prints. In this case, it is possible to produce the test print on a photosensitive sheet by the same method.

When test print 15 is produced by the above method, there is the problem of defining the partial desired area of the frame to be selected through the slit, while the photographic film is advanced, which is drawback in workability. Specifically when the defined area in the frame does not agree with the opening direction of the slit, the area for cropping must be determined after the film direction is turned around, which is very bad for the production. Further, by turning the direction of the film, foreign article such as dust can adhere to the film, which inevitably deteriorates the print quality.

Further, test prints 15 are continuous and the rectangular cropping images are successively printed, it is necessary to correlate the rectangular prints to each frame of the photographic film, and specifically it is very difficult to correlate them when there are a great number of these rectangular prints. Though there is a method wherein print information such as the order number, the frame number of the photographic film, and the printing settings, are printed on the rear surface of the photosensitive material, the operator must determine the correction level of the color balance while correlating the frame of the film to the test prints, by watching the test prints and signs or numerals printed on the rear surfaces of the test prints, which is cumbersome for work rate.

### SUMMARY OF THE INVENTION

The present invention was achieved in view of the above problems, and the objective of the present invention is to provide a test print, a test print production system and a test print production method, wherein both the test print area and adjustment of the actual printing settings are simply determined, and wherein consumption of the photographic materials for the test prints is greatly reduced.

In order to attain the above objectives, in a test print of the present invention, the area for cropping the image is assigned and selected from the frame recorded on the photographic film, and a plurality of the cropped areas are printed linearly on a photosensitive roll or sheet, wherein information for identifying the cropped images correlating to the image frame recorded on the photographic film, is printed on the same surface as the cropped images.

Further, in the test print of the present invention, the area for cropping the image is assigned and selected from the frame recorded on the photographic film, and a plurality of the cropped areas are printed linearly on the photosensitive material, wherein both the information for identifying the cropped images correlating to the image frame recorded on the photographic film, and

information for the printing settings of the cropped image, are printed on the same surface as the cropped images printed on the photosensitive material.

Still further, in the present invention, it is possible to use a structure wherein order information correlating to the photographic film is printed on the same surface as the cropped images printed on the photosensitive material.

Further, a test print production system of the present invention includes:

a reading means which scans the photographic film and reads out images recorded on the photographic film;

a display means which displays the read-out images;

a cropping means which determines an area from the read-out image, for making a test print, on a display of the display means, and which selects the cropped image specified by the determined area;

an image combining means

which linearly arranges the cropped images, based on a predetermined rule, and

which combines both

information for identifying the image on the photographic film correlating to the cropped and printed image, and information about the printing settings of the cropped image,

by correlating to the cropped image; and

a printing means which produces the prints of both the linearly arranged cropped images, and the information, on the same surface.

Further in the present invention, it is possible to use a structure wherein the test print production system further includes a correction means, and thereby color correction is conducted on the images or the cropped image.

Still further in the present invention, it is possible to use a structure wherein the test print production system further includes a memory means, and thereby printing settings, inherent to the customer who orders the print, are stored in the memory means.

Still further, in the present invention, it is possible to use a structure wherein the image combining means combines ordering information correlating to the photographic film.

Yet further, in the present invention, it is possible to use a structure wherein a frame of a predetermined shape or plural markers are operationally displayed on the display means, and thereby the cropping means determines the test print area, using the area surrounded by the frame or an area surrounded by lines connected to the plural markers.

In addition, in the present invention, it is possible to use a structure wherein the image combining means decreases, increases, and rotates the cropped image so that the cropped image correlating to each image becomes the predetermined shape.

A test print production method of the present invention includes:

a reading step which scans the photographic film and reads out images recorded on the photographic film;

a display step which displays the read-out images;

a cropping step which determines, the area from the read-out image for making a test print, on a display of the display means, and which selects the cropped image specified by the determined area;

an image combining step which linearly arranges the cropped images, based on a predetermined rule, and which combines

information for identifying the image on the photographic film correlating to the cropped and printed image, and

information about the printing settings for the cropped image,

by correlating to the cropped image; and

a printing step which produces the prints of the cropped images linearly arranged, and the relevant information, on the same surface; wherein the process, in which the cropped image and the relevant information are combined and printed, is repeated so that the printing settings are determined.

Based on the above description of the present invention, without directly determining the test print area of the photographic film by the slit, image information recorded on the photographic film is read out and taken in as the image data, and the area for the test print is determined by the manual operation of the frame or the marker on the displayed means under the displayed condition, therefore it is possible to easily determine the test print area. Further without making a test print of the total area of the frame, only the areas necessary for adjustments of the finished quality, such as the color adjustment, are aligned and printed, consumption of the photosensitive materials is reduced, and the photosensitive materials are more effectively used, because the cropped images are rotated, reduced in size, and printed, without any white space remaining on the processed photosensitive material.

Further regarding test prints of the present invention, not only the cropped image which is trimmed from each frame image, but also various information such as information for identifying the frame image correlating to the cropped image, information for the printing settings or for the color correction, and information for identifying the order are printed on the same surface as the cropped image. Therefore, the cropped image is easily correlated to the frame image, and the correction level is easily set, and accordingly, the number of the trials of the test prints can be reduced. Still further since the printing settings which are favorable to each customer are stored in the memory means, the printing settings which are preferred by each customer can be easily set up, and the number of the trials of the test prints is reduced, and thereby consumption of the photosensitive material is also reduced.

A test print of digital image taken by the digital camera, of the present invention, includes the photo-printed roll wherein the identification information is printed adjacent to and on the same surface as each test print area. Further the test print of the digital image taken by the digital camera, includes

the photo-printed roll wherein a printer setting information for producing an actual print with a desired color balance as well as the identification information are printed adjacent to and on the same surface as each test print area.

Still further, the test print of the digital image data includes the photo-printed roll wherein an order information correlated to the digital image data is printed on the same surface as the test print area.

Based on the test prints, the effects of the test print production system and the test print production method of the present invention, will now be described below.

The first effect of the present invention is an easier operation for determining the area for the test print.

Because the operator reads out image information of the photographic film or the digital media and uses them as digital image data, which are displayed on the display screen, and then the operator can determine the area for the test print by manipulating the frame or the marker, instead of determining the area for the test print using a slit, while moving the photographic film as necessary.

The second effect of the present invention is the high efficiency of the operation for determining the printing settings.

Because information for identifying the frame image correlates to the cropped image, information for color adjustment, information for specifying the order as well as the cropped images, are printed on the same surface as the test print, the cropped images are easily correlated to the frame image, and the printing settings are easily set. Further, since favorable printing settings for each customer are stored in the memory means, the printing settings are easily established by referring to the stored favorable printing settings.

The third effect of the present invention is the reduction of waste of the photosensitive material.

Because the total image frame is not printed, but only the necessary and specific area for establishing the printing settings is cropped from the frame, and each cropped image is aligned and printed, which forms one test print. When the cropped images are aligned, the cropped images can be rotated, reduced or increased in size, and printed, without any excessive white spaces remaining on the photosensitive material, and thereby the photosensitive material is most effectively used. Further, setting operations of the printing settings is achieved very easily so that the number of the trials of the test prints can be reduced, which also reduces the consumption of photosensitive material.

### BRIEF DESCRIPTION OF THE DRAWINGS

FIG. 1 shows a schematic structure of a test print production system, related to an embodiment of the present invention.

FIG. 2 is a block diagram of a test print production system, related to an embodiment of the present invention.

FIG. 3 is a flowchart showing the procedure of producing the test print, related to an embodiment of the present invention.

FIG. 4 is a drawing which explains a method (the first determining method) for determining the test print area, in the test print production method, related to an embodiment of the present invention.

FIG. 5 is a drawing which explains a method (the second determining method) for determining the test print area, in the test print production method, related to an embodiment of the present invention.

FIG. 6 is a drawing to explain a method (the third determining method) for determining the test print area, in the test print production method, related to an embodiment of the present invention.

FIG. 7 shows a structure of the test prints, related to an embodiment of the present invention.

FIG. 8 shows another structure of the test prints, relating to an embodiment of the present invention.

FIG. 9 shows the production method of the photographic prints, wherein rolled photosensitive material is used.

FIG. 10 shows the production method of the photographic print, wherein cut photosensitive material is used.

FIG. 11 is a flowchart showing the production procedure of conventional test prints.

FIGS. 12 and 13 show the structure of conventional test prints.

### DETAILED DESCRIPTION OF THE PREFERRED EMBODIMENT

In the preferred embodiment of the test print production system of the present invention, the test print production system includes:

a reading means which reads out images recorded on the photographic film and takes them in as digital image data;

a memory means in which the image data and the printing settings for each customer are stored;

a display means on which the read-out images are displayed;

a test print data production means by which the test print data are produced; and

a print production means by which the test print is produced, with the test print data based on the selected printing settings.

It is therefore possible to display the image data read out from the photographic film on the display means, and to easily determine the area for the test print by the cropping means. Further it is possible to determine the test print area, to align the cropped images effectively, to produce the test prints, and thereby to reduce wasteful use of the photosensitive material.

Still further, the cropped image, information for identifying the original frame image of the film, information for the printing settings and for color correction, as well as information for identifying the order, are printed on the printed surface, all of which are very effective for determining the printing settings.

In addition, the printing settings which are appropriate to each customer are stored in the memory means, and used for adjusting the printing settings, therefore, the number of the trials of the test prints for obtaining the desired print quality can be reduced, and consumption of the photosensitive materials will also be reduced.

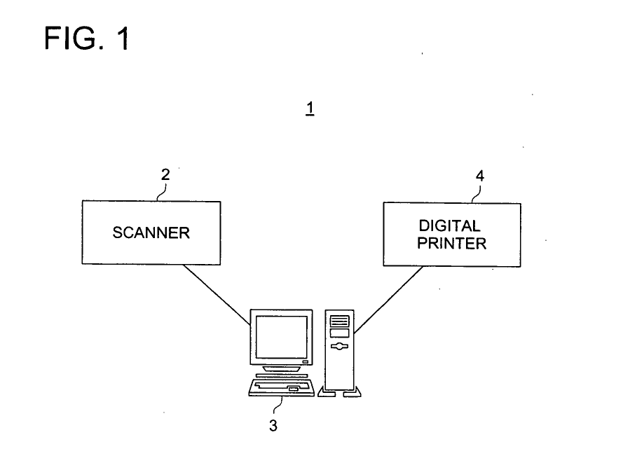

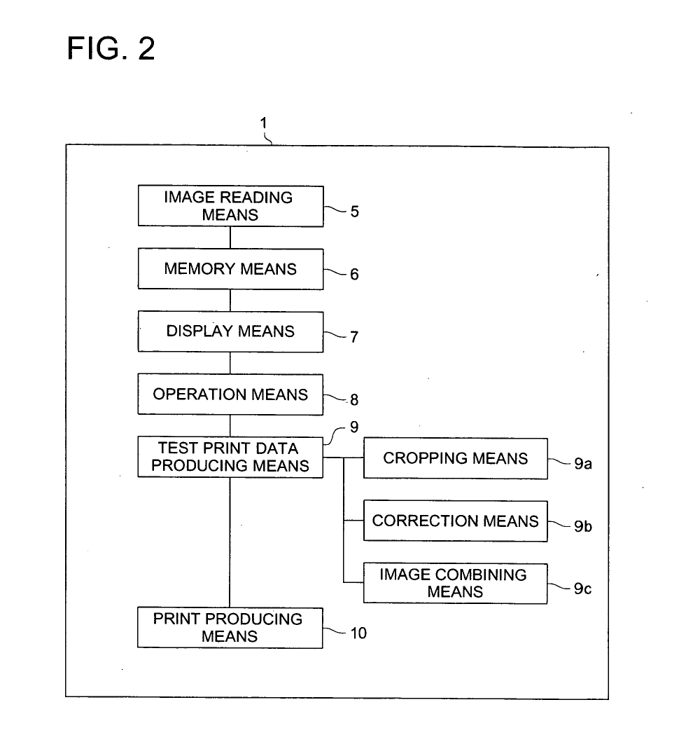

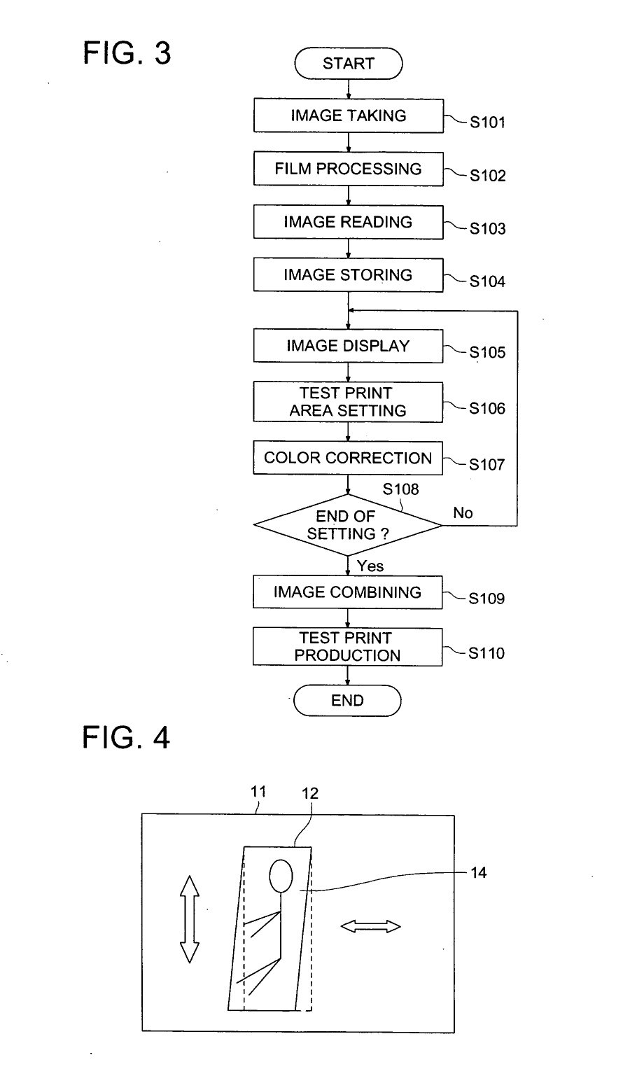

In order to more clearly explain the embodiments of the present invention, the test print, the test print production system and the test print production method, related to the embodiments of the present invention will now be explained in detail, referring to FIGS. 1-8. FIG. 1 shows the structure of the test print production system, related to the embodiments of the present invention, and FIG. 2 is a block diagram of the test print production system. FIG. 3 is a flowchart showing the procedure of producing the test prints, related to an embodiment of the present invention.

FIGS. 4-6 explain a method for determining the test print area.

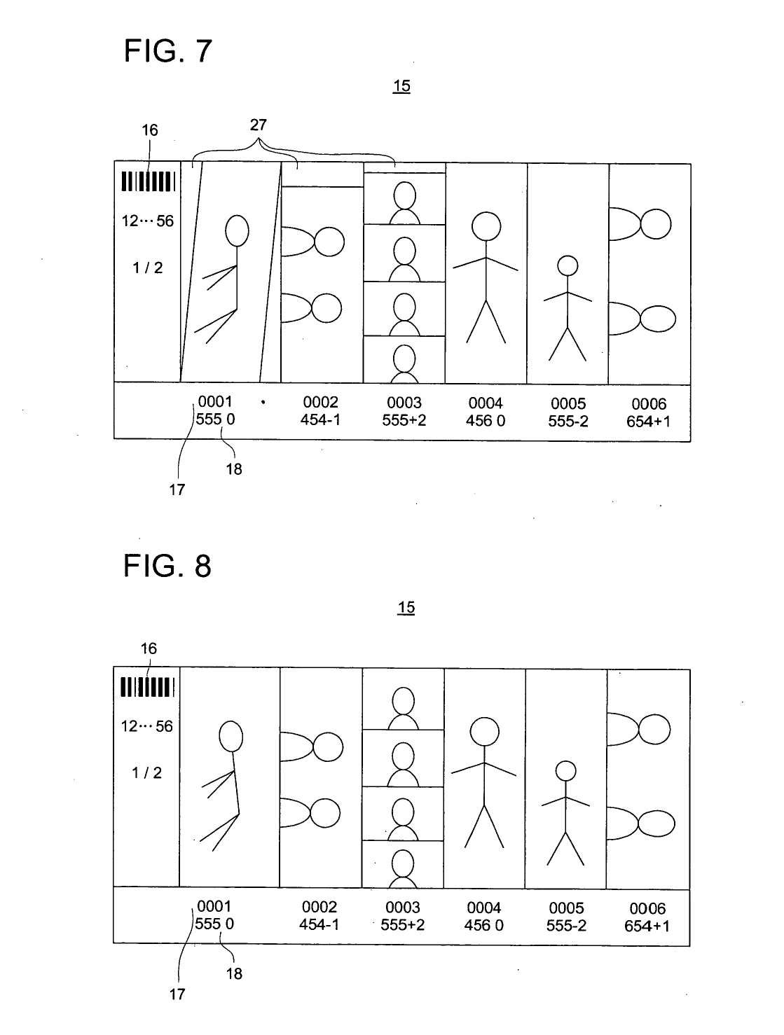

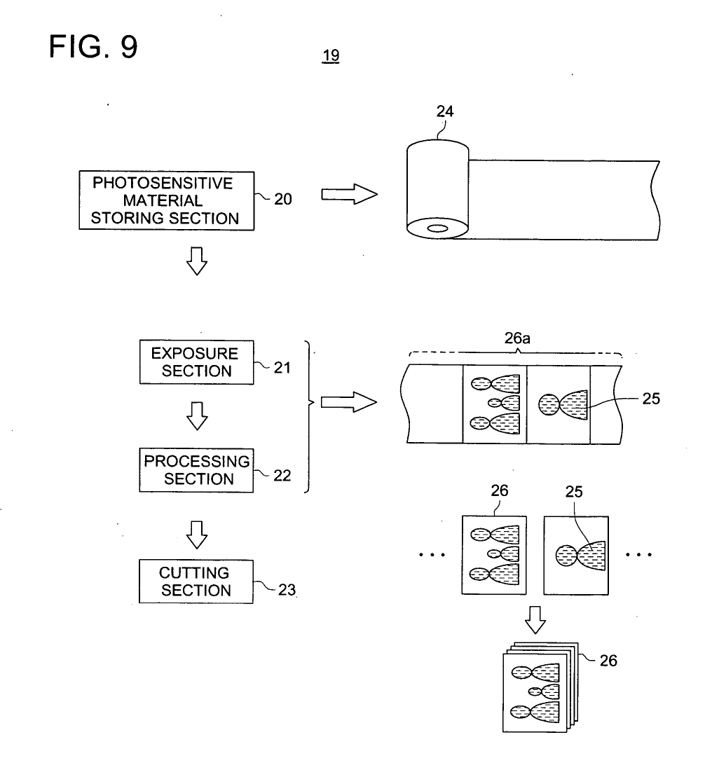

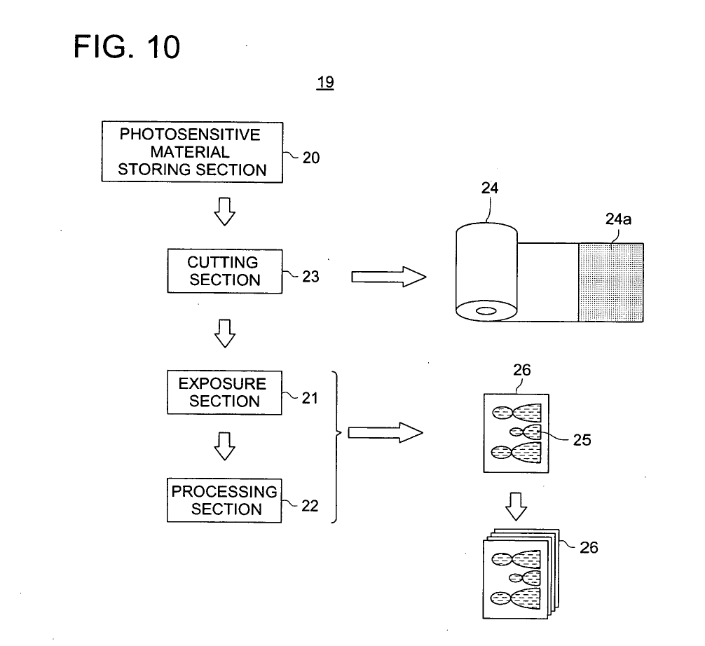

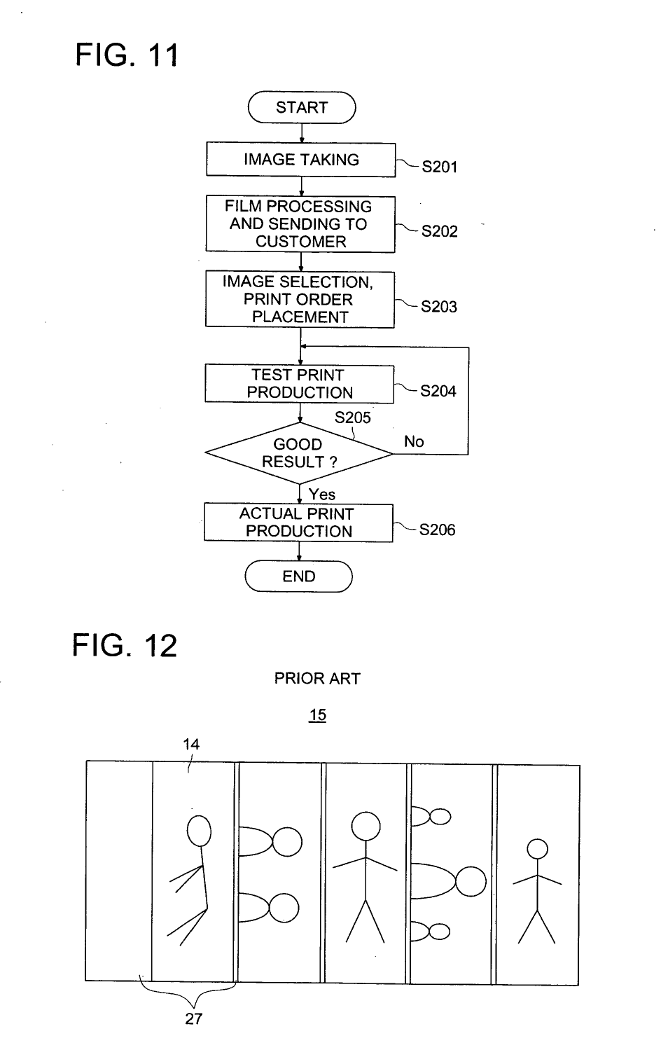

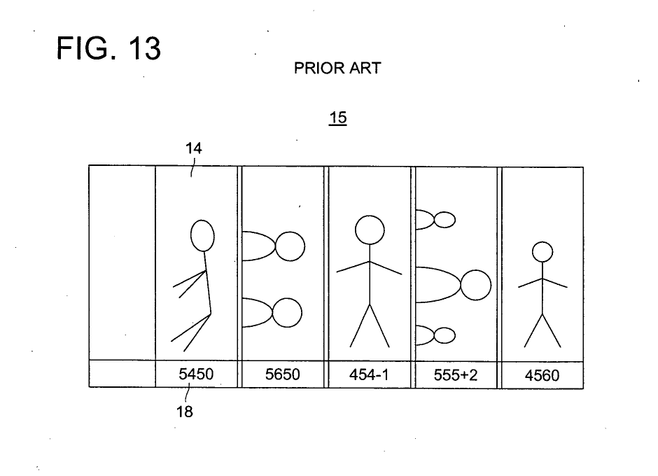

FIGS. 7 and 8 show the structure of the test prints which are produced by a method of an embodiment of the present invention.

As shown in FIG. 1, the test print production system of embodiment 1 includes:

scanner 2 which reads out image information recorded on the processed photographic film and converts this information to digital image data;

a computer terminal, such as personal computer 3, displays the image data read-out by scanner 2 on the display means and determines the test print area, and combines information for the image of the test print area (hereinafter referred to as a cropped image) and information for the cropped image; and

printing means, such as digital printer 4, for producing the test prints and the actual photographic print, using the printing settings determined by personal computer 3.

In this embodiment, a test print is not produced individually, but plural cropped images are exposed and printed continuously, therefore, digital printer 4 is commonly a printer employing the roll conveyance method wherein the cropped image are exposed and printed on rolled photosensitive material, after which each image is cut to the desired size. Further, since FIG. 1 shows a basic structure of test print production system 1 of the present embodiment, it is possible to include other apparatus such as photographic processing apparatus, in addition to scanner 2, personal computer 3 and digital printer 4.

The means for test print production system 1 is shown in FIG. 2. That is, test print production system 1 includes:

image read-out means 5 for scanning the image information recorded on the processed photographic film, and taking in the image information as digital image data;

memory means 6 for storing the read-out image data grouped for each customer, as well as the preferred printing settings for each customer;

display means 7 for displaying individual frame images based on the read-out digital image data;

operation means 8 for determining the test print area and other operations;

test print data production means 9 for producing the data for the test print; and

print production means 10 for producing the test prints and the actual photographic prints, based on the determined printing settings.

Still further, test print production means 9 includes:

cropping means 9a for determining the test print area from the displayed frame image;

correction means 9b for performing corrections, such as for color adjustment, to obtain the desired printing settings; and

image combining means 9c for combining the plural cropped images and information, such as information for identifying the frame image correlating to each cropped image, information for the printing settings and color adjustment, as well as information for specifying the customer's order.

Referring to the flowchart in FIG. 3, the procedure of the test print production, which employs test print production system 1 of the above structure, will now be explained.

Firstly, in step S101, the customer (for example a photographic studio) takes a picture using photographic film, which is a rolled film housed in a cartridge or Brownie size film, and takes the image-exposed film to a photo-finishing laboratory, such as a mini-laboratory. In conventional test print production methods, since the test print area is determined after the film is moved or rotated, if there are various types or sizes of photographic film, the work rate of test prints making becomes very low, which is a major drawback. However in the present embodiment, image. information of the photographic film is read out and is taken as digital image data in the next procedure, and which are displayed on the display means, whereby the test print area is determined, and therefore the present embodiment does not generate the stated bad problem even when there are various types or sizes of photographic film.

Next, in step S102, in the photo-finishing laboratory, the customer's photographic film is processed by a processing apparatus, and in step S103, the image information on the photographic film is read-out by image reading means 5 such as scanner 2, and the image information is converted to digital image data, after which the read-out image data are stored in memory means 6. In this case, in order to recognize the image data related to each order, virtual folders for each order are previously formed in memory means 6, and thereby the image data are stored together in the correlating folders.

In the conventional test print production methods, in order to select the frame image to be test-printed, the processed photographic film is sent back to the customer and the customer selects the frame images from the film. However, in the test print production method of the present embodiment, since all of the frame images are read out and stored as digital image data, there is no need for the photo-finishing laboratory to send back the processed photographic film to the customer, and further there is no need for the customer to select the frame images.

Next in step S105, the digital image data stored in each folder for each order are sequentially read out from memory means 6, and are displayed on display means 7. In step S106, the test print areas are determined for each image based on each image datum. In the conventional methods, the test print area is determined by the slit installed in the test print producing apparatus, the size and shape of the area cannot be determined with freedom, and further the test print area is determined while the film is moved, which can take a long time and great skill, to determine the test print area. Still further, when the area to be test-printed does not agree with an opening direction of the slit, the feeding direction of the film must be changed, which adversely affects work rate, and by changing the feeding direction of the film, foreign matter such as dust can adhered onto the film, which deteriorates print quality.

For a countermeasure of this problem, in the present embodiment, for the frame image displayed on display means 7, the test print area is determined on the display, and thereby the size and shape of the test print area is freely determined, and the operation for determining the test print area is easily performed. Further when the test print area slanting to the edge of the frame is to be determined, there is no need to rotate the photographic film, and accordingly, the test print area is easily determined, which results in a more effective work rate.

Specifically, there are three methods for the determining method of the test print area. In the first determining method, shown in FIG. 4, bounding trim 12 having a predetermined size is displayed on display screen 11, and bounding trim 12 is moved vertically or perpendicularly, expanded or contracted, or changed in shape, by operating means 8 such as a mouse or arrow keys, and whereby the test print area is determined. In this method, the test print area is easily determined by bounding trim 12 so that cropped image 14 can be selected, and by using bounding trim 12 having a predetermined size, it is possible to form cropped image 14 in a predetermined size.

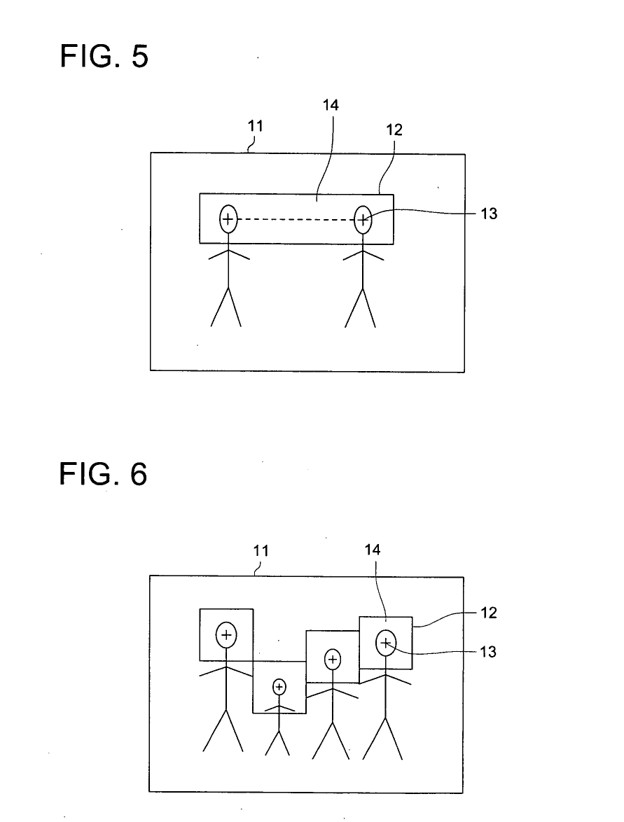

In the second determining method, the test print area is determined by plural markers. For example, when the total image of a person is test-printed, determining the area by bounding trim 12 is more convenient, but when an area whose center is in the predetermined section (faces, for example) of plural persons, to determine the area via marker is more convenient. Therefore, as shown in FIG. 5, marker 13 is moved to the predetermined position (the faces of the persons at both ends) by operation means 8 such as a mouse or arrow keys, after which the mouse is clicked to determine the position, so that bounding trim 12, which surrounds the area (which is a straight line, in the case of two points) connected by plural markers 13, is automatically displayed. Based on this method, the area which is centered on the section to be test-printed is determined, and thereby the result of color adjustment is easily understood.

In the third determining method, plural test print areas are separately determined, as shown in FIG. 6, there are plural persons. When the position of the predetermined sections (the faces for example) are spread out, and when the test print area is determined by one bounding trim 12, the area becomes excessively large, which is a waste of photosensitive materials. In this case, marker 13 is moved to the center of the section to be test-printed and confirms, bounding trim 12 which surrounds marker 13 can be automatically displayed. Based on this method, the area to be test-printed is determined to a predetermined size, and thereby the result of the color adjustment is easily judged. As described above, three methods are exemplified, but it is possible to also employ any other method which can simply and correctly determine the test print area.

After the test print area is determined by any one of the above described methods, correction processes such as for color adjustment is performed in step S107, to obtain the desired printing settings of the image displayed on display means 7. These correction processes can be respectively performed for each image, or can be performed for all of the images under the same condition. Further the level of correction can be determined based on the standard printing settings previously stored in memory means 6, or the printing settings previously determined for each customer, and the desired printing settings can be easily determined by the printing settings respectively determined for each customer, while reducing the number of trials of the test prints. Further in this case, the correction process such as a color for adjustment is performed after the test print area is determined, however, the test print area can also be determined after the correction process for the frame image.

After both the test print area and the correction process such as color adjustment for all of the images are determined in step S108, cropped images 14, for which the correction process were completed by image combining means 9, are linearly arranged based on the displayed order (when plural cropped images are selected in the third method shown in FIG. 6, the cropped images are arranged into one group to form a rectangular.), and further, various information, such as information for identifying the frame image correlating to each cropped image, information for the printing settings and the color correction, and information for specifying the order, are combined around each cropped image 14 or in each cropped image 14. In this case, the order of the cropped images 14 can be randomly arranged, that is, the order of the frame numbers, or the order of the file names of the image data can be used. Further, information displayed with the cropped images can be information which is usable for determining the printing settings.

In step S110, in print production means 10, the image, featuring combined cropped image and related information, is exposed on a section of the rolled photosensitive material which was drawn out from photosensitive material storage section 20, and then that section of the photosensitive material is processed so that the test print is produced. For example, as shown in FIG. 7, this test print is formed in such a way that rectangular cropped images 14 are continuously displayed, and both information (image identifying information 17) for identifying the image, and information (printing settings information 18) for the printing settings and color correction, are correlated for each cropped image 14 (under cropped image 14 in FIG. 7), and displayed, and further information (order identifying information 16) for identifying the order is displayed at the top (left end of FIG. 7) of test print 15, by text information or coded information. When there are a number of cropped images and a sheet of the cut section of rolled photosensitive material for the test prints becomes too long, plural but shorter sheets of the test prints can be produced, preferably having page numbers for checking each sheet (in FIG. 7, at the top of the test print, “1 of 238 is printed, showing a first sheet of total two sheets).

In the conventional test print method, only cropped images 14 are displayed on the printed surface of the photosensitive material, while image identifying information and the printing settings information are printed on the rear surface of the photosensitive material, and thereby, it is very difficult to correlate the cropped image to the frame image of the photographic film, and to determine the printing settings for each frame image. However, in the present embodiment, image identifying information 17 and printing settings information 18 are printed on the same surface as the cropped image 14, and thereby, it is possible to correlate the cropped image to the frame image of the photographic film with ease, and further to easily determine the printing settings as well.

In addition, in the first determining method, when bounding trim 12 is changed in shape, the cropped image does not necessarily become rectangular, and thereby white space 27 is generated between adjacent cropped images 14. Further when plural cropped images 14 are formed from a single frame image, the arranged shape of plural cropped images does not become rectangular, and thereby white space 27 is generated, and if white space 27 covers a large area, wasteful amounts of photosensitive material results. In this case, when the shape of cropped images 14, which were formed by image combining means 9c, is not a predetermined rectangle, it is possible to automatically adjust the shape of cropped image, by rotating, and expanding or contracting the image, in order to reduce generation of white space.

For example, in FIG. 7, since cropped image 14 at the left end is a parallelogram, white space 27 is generated between the adjacent cropped images 14. In this case, if cropped image 4 is slightly rotated (in this example, rotated counterclockwise), the white space is not generated as shown in FIG. 8. Further, concerning second and third cropped images 14 from left in FIG. 7, the ratio of their long edge and short edge are not equal to the ratio of the predetermined rectangle, and thereby white space 27 is generated at the upper edge. In this case, by expanding or contracting the cropped image 14 (in FIG. 7, by expanding vertically), white space is not generated as shown in FIG. 8. That is, by giving the adjusting function of the shape of the cropping image to image combining means 9c, the photosensitive material can be more effectively utilized.

As explained above, in the test print production method of the present embodiment, since image information of the photographic film is read out and is used as digital image data, and is displayed by display means 7, and further, the test print area is determined by cropping means 9a on the display screen, the work rate of producing the test prints is greatly increased. Further, not only are cropped images 14 continuously printed, but also various kinds of information such as image identifying information 17, printing settings information 18 and order identification information 16 are printed on the same surface, and thereby the cropped images are easily correlated to the frame image, and the printing settings are easily determined. Still further, since cropped images 14 are arranged to produce test print 15, the photosensitive material is more effectively used, and still further, since the printing settings for each customer are store in memory means 6, the number of trials of the test prints for obtaining the desired printing settings can be reduced, and the consumed amount of photosensitive material can be reduced.

Additionally, in the case that the test print is performed for the image data stored in the digital image capturing media, the present invention can effectively obtain the printer settings using the test print, which is the same as the case of the processed photographic film.

1. A test print of a processed photographic film, comprising:
a photo-printed roll or sheet wherein
a plurality of test print areas which are selected and cropped from image frames of a processed photographic film are linearly printed, and
identification information about the test print area correlating to each image frame are printed on the same surface as the test print area of each image frame.

2. The test print of the processed photographic film, comprising:
the photo-printed roll or sheet wherein a printer setting information for producing an actual print with a desired color balance as well as the identification information are printed adjacent to and on the same surface as each test print area.

3. The test print of the processed photographic film in claim 1, comprising:
the photo-printed roll or sheet wherein an order information correlated to the photographic film is printed on the same surface as the test print area.

4. A test print producing system of a processed photographic film, comprising:
a reading device for scanning and reading out an image frame of the processed photographic film;
a display device for displaying the image frame;
a cropping device for determining a test print area of the frame image, on the display device;
an image combining device for arranging the test print areas in accordance with a predetermined rule, and for combining the test print area and either one of
identification information for identifying the image frame correlating to the test print area, or
printer setting information for printing the test print area; and
a printing device for printing the identification information, the printer setting information and the test print area on the same surface.

5. The test print producing system in claim 4, further comprising:
a correction device for performing color correction about the test print area or the image frame.

6. The test print producing system in claim 4, further comprising:
a memory device for memorizing printer setting condition which is identical to a user.

7. The test print producing system in claim 4, wherein an order information correlating to the photographic film is combined to the test print area, in the image combining device.

8. The test print producing system in claim 4, wherein a bounding trim of predetermined shape or plural markers are displayed and operated on the display device, and wherein an area surrounded by the bounding trim or lines connecting the plural markers is determined as the test print area, in the cropping device.

9. The test print producing system in claim 4, wherein the cropped images are rotated, reduced or increased in size so that the test print areas become an uniformed shape, in the image combining device.

10. A test print producing method, comprising a step of:
scanning and reading out an image frame of a processed photographic film;
displaying the image frame;
determining a test print area of the frame image;
arranging the test print areas in accordance with a predetermined rule, and combining the test print area and either one of
identification information for identifying the image frame correlating to the test print area, or
printer setting information for printing the test print area; and
printing the identification information, the printer setting information and the test print area on the same surface,
combining the test print area, the identification information and printer setting information, and repeating test prints until a printer setting condition is determined.

11. The test print producing method in claim 10, further comprising a step of:
performing color correction about the test print area or the image frame;
combining the test print area to which color correction is performed, the identification information, and printer setting information, and
repeating test prints until a printer setting condition is determined.

12. The test print producing method in claim 11, further comprising a step of:
memorizing a printer setting condition which is identical to a user, and
setting the color correction referring to the printer setting condition which is identical to the user.

13. The test print producing method in claim 10, further comprising a step of:
combining an order information correlating to the photographic film to the printed test print area, in the image combining device.

14. The test print producing method in claim 10, further comprising a step of:
displaying a bounding trim of predetermined shape or plural markers on the display device, and setting an area surrounded by the bounding trim or lines connecting the plural markers as the test print area.

15. The test print producing method in claim 10, further comprising a step of:
rotating the test print area, reducing or increasing a size of the test print area so that the test print areas become an uniformed shape.

16. The test print of digital image data, comprising:
the photo-printed roll or sheet wherein the identification information is printed adjacent to and on the same surface as each test print area.

17. The test print of the digital image data, comprising:
the photo-printed roll or sheet wherein a printer setting information for producing an actual print with a desired color balance as well as the identification information are printed adjacent to and on the same surface as each test print area.

18. The test print of the digital image data in claim 16, comprising:
the photo-printed roll lo sheet wherein an order information correlated to the digital image data is printed on the same surfaces as the test print area.
